(19) United States
(12) Patent Application Publication
(10) Pub. No.: US 2007/0284561 A1
(43) Pub. Date: Dec. 13, 2007

(54) Structure of driving lever for car jack

(76) Inventors: Ting-Hsien Wang, Tali City (TW); Caesar Shih, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/451,394

(22) Filed: Jun. 13, 2006

(51) Int. Cl. B60P 1/48

(52) U.S. Cl. 254/8 B

(57) ABSTRACT

A driving lever includes an elongated lever body, a coupling tip at one end of the lever body for securing a socket for turning screws and bolts, a grip at the other end of the lever body, and an extension rod, which has a peripheral locating pin for securing the extension rod to the driving head of a car jack for enabling the driving lever to lift the car jack and a retaining hole in the distal end for securing the extension rod to the rotary lock bolt of the same car jack to lock the hydraulic system of the car jack.

### BACKGROUND OF THE INVENTION

1. Field of the Invention

The present invention relates to a car jack and more specifically, to a driving lever for car jack that can be used as a spanner when detached from the car jack.

2. Description of the Related Art

FIG. 1 illustrates a conventional car jack. As illustrated, the car jack 10 has a driving head 11, a driving lever 14 detachably attached to the driving head 11 for turning by the user to bias the driving head 11 and to further lift the car jack, and a rotary lock bolt 13 for locking the hydraulic system to hold the car jack in the lifted position. The driving head 11 has a locating notch 12. The driving lever 14 has a locating pin 15 at the periphery. After insertion of the driving lever 14 into the driving head 11, the driving lever 14 is rotated through an angle to force the locating pin 15 into positive engagement with the locating notch 12 so that the driving lever 14 can be pulled alternatively up and down to lift the car jack. This design of car jack has drawbacks as follows:

1. The driving lever 14 is specifically designed for driving the driving head 11, not usable for other purposes.

2. When wishing to rotate the rotary lock bolt 13, the user must prepare a spanner or wrench.

### SUMMARY OF THE INVENTION

The present invention has been accomplished under the circumstances in view. It is the main object of the present invention to provide a driving lever for car jack, which can be used as a spanner when detached from the driving head of the car jack.

To achieve this and other objects of the present invention, the driving lever comprises an elongated lever body, a coupling tip extending from one end of the elongated lever body for securing a socket for turning a screw bolt or nut, a grip fixedly provided at an opposite end of the elongated lever body for the holding of the hand, and an extension rod axially extending from one end of the grip opposite to the elongated lever body and selectively attachable to the driving head and rotary lock bolt of a car jack. The extension rod has a locating pin perpendicularly extended from the periphery thereof for engagement with a locating notch of the driving head to which the extension rod is attached, and a retaining hole axially formed in a distal end thereof for securing to the rotary lock bolt of a car jack for enabling the driving lever to rotate the rotary lock bolt of the car jack.

### BRIEF DESCRIPTION OF THE DRAWINGS

FIG. 1 is an exploded view of a conventional car jack.

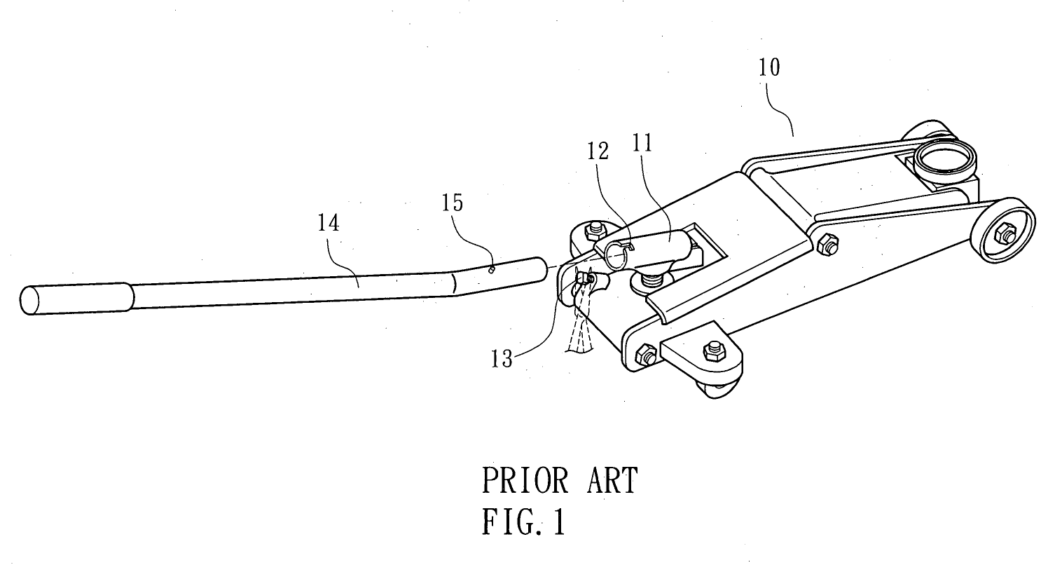

FIG. 2 is an elevational view of a driving lever for car jack according to the present invention.

FIG. 3 is a schematic drawing showing the driving lever secured to the driving head of a car jack and pulled alternatively up and down according to the present invention.

FIG. 4 is a schematic drawing showing the driving lever secured to the rotary lock bolt of the car jack and turned.

FIG. 5 is an elevational view of an alternate form of the driving lever according to the present invention.

FIG. 6 is an elevational view of another alternate form of the driving lever according to the present invention.

### DETAILED DESCRIPTION OF THE PREFERRED EMBODIMENT

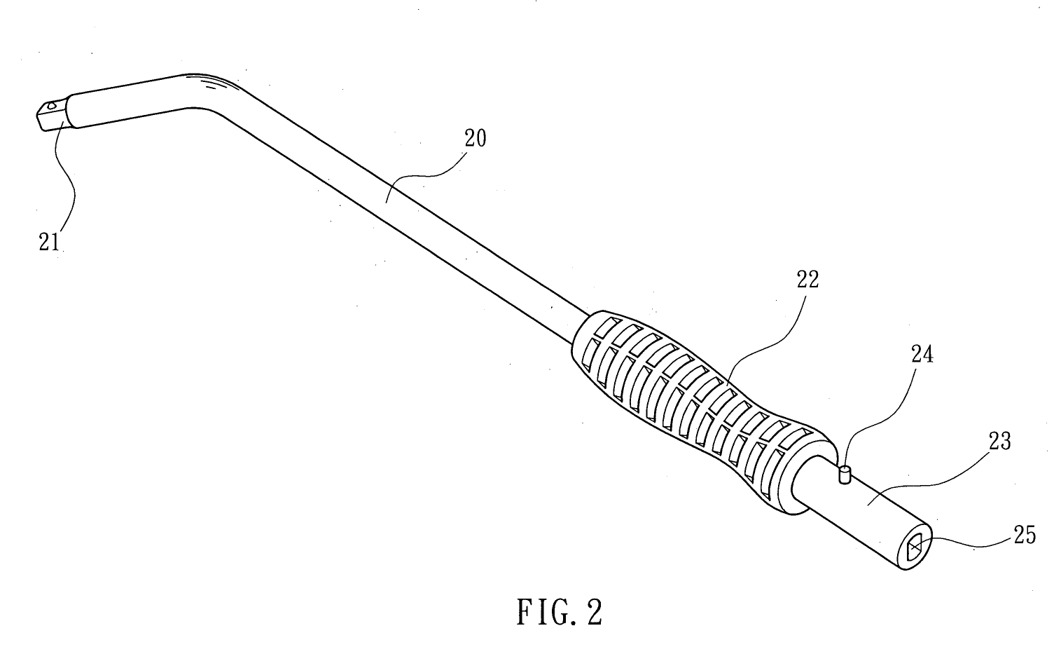

Referring to FIG. 2, a driving lever for car jack in accordance with the present invention is shown comprising an elongated lever body 20, a coupling tip 21 extending from one end of the elongated lever body 20 for securing a socket for turning a screw bolt or nut, a grip 22 fixedly provided at the other end of the elongated lever body 20 for the holding of the hand, and an extension rod 23 axially extending from one end of the grip 22 opposite to the elongated lever body 20. The extension rod 23 has a locating pin 24 perpendicularly extended from the periphery, and a retaining hole 25 axially formed in the distal end of the extension rod 23 remote from the grip 22.

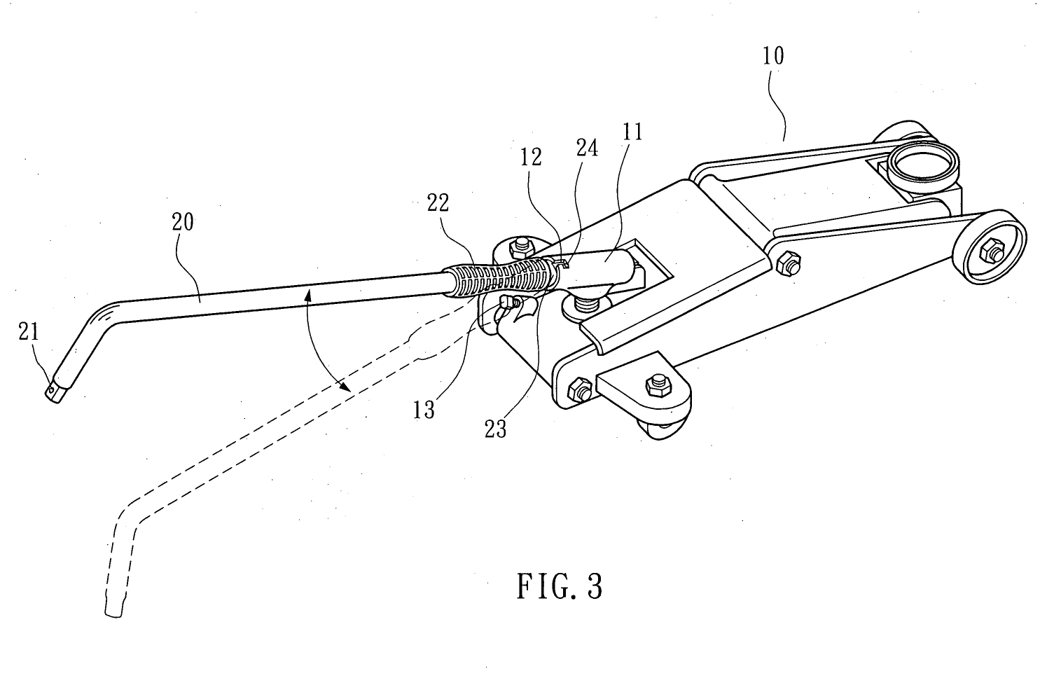

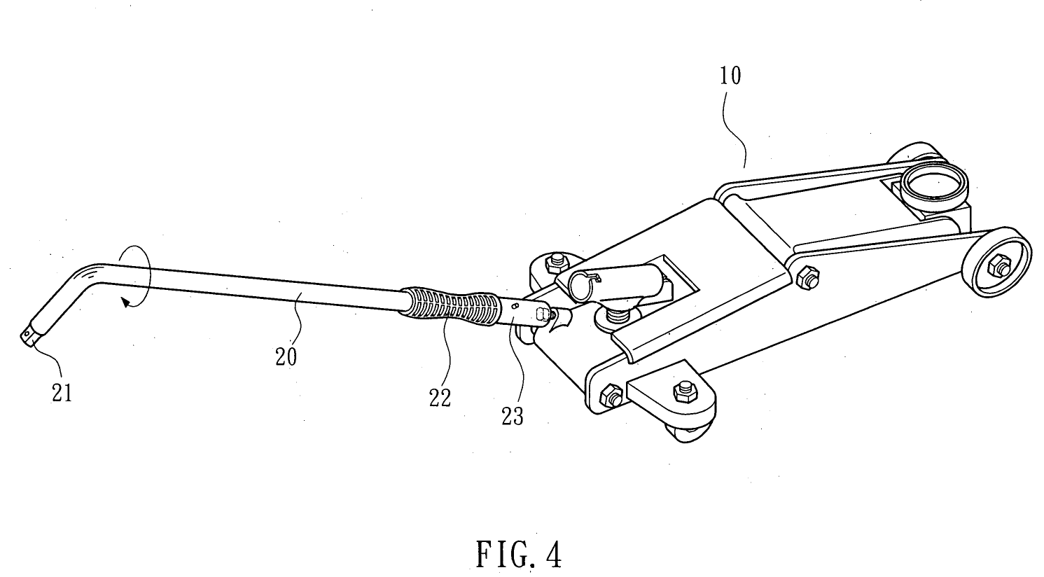

Referring to FIGS. 3 and 4, the driving lever of the present invention can be used to drive the driving head 11 of a car jack 10 or to rotate the rotary lock bolt 13 of the car jack 10. As shown in FIG. 3, the extension rod 23 of the driving lever is inserted into the driving head 11 of the car jack 10 and then the driving lever is rotated through an angle to force the locating pin 24 into positive engagement with the locating notch 12 of the driving head 11 of the car jack 10 so that the driving lever can be pulled alternatively up and down to lift the car jack. As shown in FIG. 4, by means of the retaining hole 25, the driving lever is attached to the rotary lock bolt 13 of the car jack 10, and then the driving lever is turned to rotate the rotary lock bolt 13 between the locking position and the unlocking position.

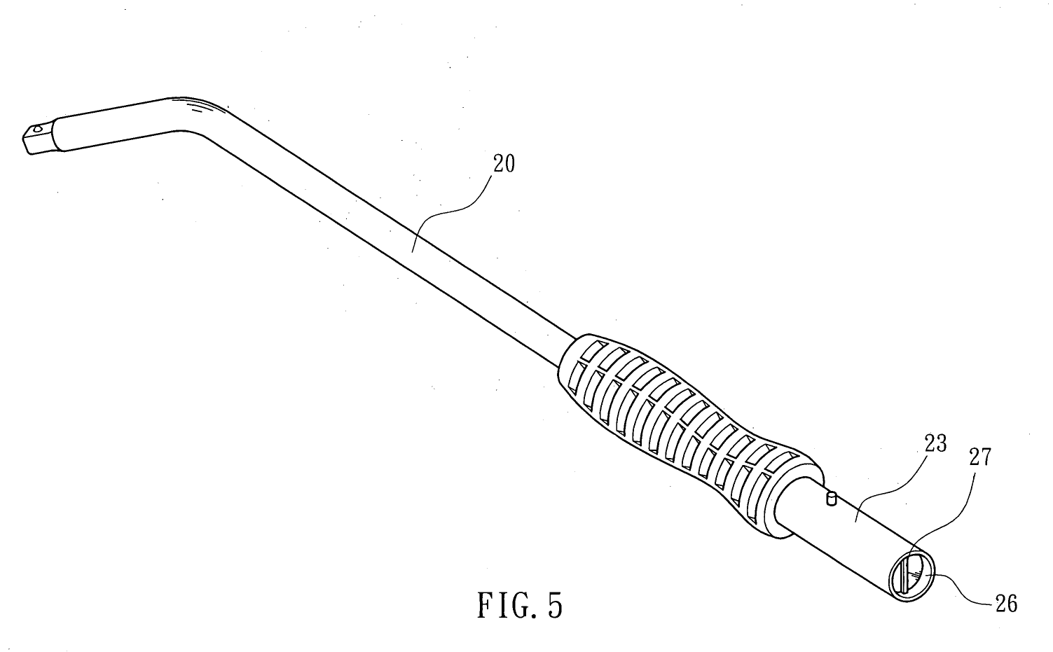

FIG. 5 shows an alternate form of the driving lever according to the present invention. According to this embodiment, the extension rod 23 has a circular retaining hole 26 axially formed in the distal end and a transverse rib 27 suspending in the circular retaining hole 26.

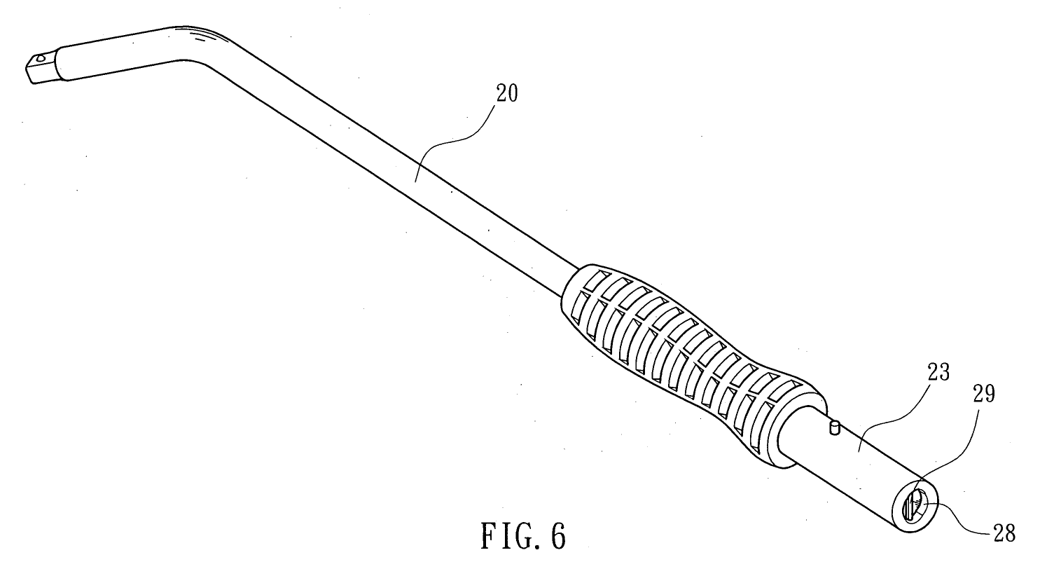

FIG. 6 shows another alternate form of the driving lever according to the present invention. According to this embodiment, the extension rod 23 has a retaining hole 26 shaped like the plume flower and axially formed in the distal end and a transverse rib 27 suspending in the retaining hole 26.

The embodiments shown in FIGS. 5 and 6 are adapted to rotate a bolt having a slotted head.

Although particular embodiments of the invention have been described in detail for purposes of illustration, various modifications and enhancements may be made without departing from the spirit and scope of the invention.

1. A driving lever for a car jack comprising an elongated lever body, a coupling tip extending from one end of said elongated lever body for securing a socket for turning a screw bolt or nut, a grip fixedly provided at an opposite end from said coupling tip for use with the socket, and an extension rod axially extending from one end of said grip opposite to said elongated lever body and selectively attachable to a driving head and rotary lock bolt of a car jack, said extension rod having a locating pin perpendicularly extended from a periphery thereof for engagement with a locating notch of the driving head to which said extension rod is attached, and a retaining hole axially formed in a distal end thereof for securing to the rotary lock bolt of a car jack.

2. The driving lever as claimed in claim 1, wherein the grip has a plurality of longitudinally directed ribs in angularly spaced relationship and a plurality of longitudinally spaced annular ribs.
